(19) United States
(12) Patent Application Publication
(10) Pub. No.: US 2026/0220144 A1
(43) Pub. Date: Jul. 30, 2026

(54) SYSTEMS AND METHODS USING LARGE LANGUAGE MODELS TO GENERATE SYNTHETIC SEARCH QUERIES

(71) Applicant: Walmart Apollo, LLC, Bentonville, AR (US)

(72) Inventors: Siddharth P. Singh, Fremont, CA (US); Aditya Singh, Fremont, CA (US); Jayant Sachdev, Sunnyvale, CA (US); Chittaranjan Tripathy, Sunnyvale, CA (US)

(21) Appl. No.: 19/041,147

(22) Filed: Jan. 30, 2025

(51) Int. Cl. G06F 16/2458; G06N 3/0475; G06N 3/092

(52) U.S. Cl. CPC G06F 16/2465; G06N 3/0475; G06N 3/092

(57) ABSTRACT

Example systems and methods use trained models and large language models (LLMs) to generate synthetic search queries in connection with item searches. An example system includes: a database including past user search queries directed to items of interest to users; a processing resource; and a machine readable medium storing instructions that cause the processing resource to: generate, using a first trained model, metadata fields for an item where the first trained model uses past user search queries, an item classification showing a relationship of the item to other items, and/or the features and attributes of the item; generate, using a second trained model, a prompt to query LLMs to generate synthetic search queries that may be asked by a user; receive the synthetic search queries from the LLMs; and map, using a trained categorization model, each of the received synthetic search queries to item categories.

### TECHNICAL FIELD

This disclosure relates generally to item search queries, and more particularly, to generating search queries.

### BACKGROUND

In ecommerce and other settings, users input a user search query when searching for items of interest to them. In response to their queries, the users anticipate seeing highly relevant items identified by the search engine or interface of the ecommerce platform. It is desirable to use machine learning models, including large language models, to generate synthetic search queries that may be used to identify relevant items and item categories. Items from those relevant item categories may then be presented to the user in response to a user search query.

### BRIEF DESCRIPTION OF THE DRAWINGS

Disclosed herein are embodiments of systems, apparatuses and methods involving synthetic search queries. This description includes drawings, wherein:

FIG. 1 is a block diagram depicting an example system for generating synthetic search queries using trained models and large language models in accordance with some embodiments;

FIG. 2 is a block diagram depicting an example system for generating synthetic search queries using trained models and large language models in accordance with some embodiments;

FIG. 3 is a block diagram depicting an example system that includes a prompt involving an item and the generated synthetic search queries in accordance with some embodiments;

FIG. 4 is a flow diagram depicting an example method for generating synthetic search queries in accordance with some embodiments; and

FIG. 5 is a block diagram depicting a machine readable medium with example instructions for generating synthetic search queries in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “one form,” “some forms,” “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, the disclosure addresses using machine learning models, including large language models (LLMs), to generate synthetic search queries to improve relevancy of items returned in response to a user search query. User search queries are generally entered through an interface of an ecommerce platform, and search results relevant to the user search query can include a list of items that may be of interest to the user. In determining the search results, a search interface may map a user search query to internal item categories, and items from relevant internal item categories may be displayed to the user. Use of synthetic search queries can improve item recommendations when users search for items in new categories of items, under-engaged categories of items, in changed categories of items, and/or for items that are not frequently searched by users.

In one aspect, and without limitation, this disclosure addresses issues relating to the unequal and/or disproportionate identification of items and item categories, e.g., products and product categories, in response to user search queries. Often, search engines or interfaces may repeatedly identify the same set of item categories in response to certain user queries. The item categories that are identified are often overrepresented, while other item categories are underrepresented and not readily identified. In other words, not all categories get the same distribution of engagement with the user, and not all categories have enough similar kinds of engagement. Further, item categories or taxonomy, e.g., the relationships of similar items or items in a family to one another, may evolve over time. This taxonomy evolution may lead to cold start problems (or problems with new items), and as an item moves from one taxonomy to another, this evolution may confuse successive iterations of model improvement. As a consequence, search engines may return results that underrepresent certain item categories, especially cold start item categories (or new item categories).

In one aspect, and without limitation, this disclosure addresses two types of machine learning models, trained models and LLMs, to generate synthetic user search queries from item information and constantly evolving item taxonomy, e.g., product taxonomy or categories. Item catalogs have item expressive metadata, such as, for example, titles, color, size, or gender, along with the item taxonomy. In one aspect, this disclosure uses this information to identify the most crucial metadata fields of an item that categorize it under a specific item category. This disclosure also seeks to leverage LLMs to generate synthetic user queries that are relevant for the specific item utilizing the identified metadata. These synthetic queries may be used to add more data to query categorization models for predicting relevant item categories for user search queries and may lead to more accurate and comprehensive search results. In addition, a reinforcement learning model, such as, for example, reinforcement learning from human feedback (RLHF), may be used to fine tune the machine learning models over time using the query overrides and manual evaluation.

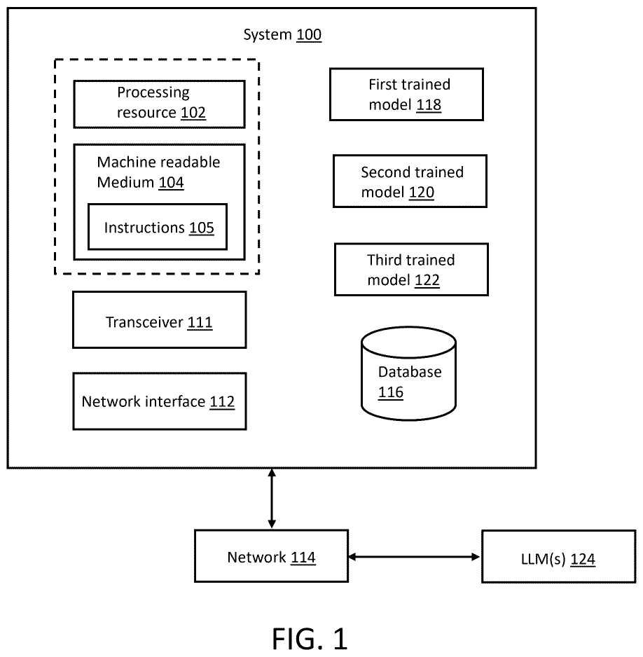

Referring now to the figures, FIG. 1 depicts an example system 100 that uses trained models and LLMs to generate synthetic search queries. As used herein, trained models generally refer to machine learning models that have been taught to perform specific tasks by training them with data sets. Large language models (LLM) are specific types of machine learning models known in the art that use data to generate outputs relating to language. As used herein, the term LLMs refers specifically to large language models, while the term trained models refers to non-LLM machine learning models.

The system 100 includes a processing resource 102 that may include a microcontroller, a microprocessor, central processing unit core(s), an application-specific integrated circuit (ASIC), a field programmable gate array (FPGA), etc. The system 100 includes machine readable medium 104 that may be non-transitory and include random access memory (RAM), read-only memory (ROM), electrically erasable programmable read-only memory (EEPROM), flash memory, a hard disk drive, etc. The processing resource 102 may execute instructions 105 (i.e., programming or software code) stored on machine readable medium 104 to perform functions of the system 100. Additionally, or alternatively, the processing resource 102 may include electronic circuitry for performing the instructions and functionality described herein.

In that regard, the processing resource 102 may be configured to execute and perform certain operations. In this context, the term processing resource 102 refers broadly to any microcontroller, computer, or processor-based device with processor, memory, and programmable input/output peripherals. As shown in FIG. 1, the processing resource 102 may be coupled to a communication transceiver 111 and a network interface 112, which, in turn, may be coupled to wireless network(s) 114. The network interface 112 may enable the processing resource 102 to communicate with other elements (both internal and external to the system 100). The network interface 112 can communicatively couple the processing resource 102 to the wireless network 114 and whatever other networks 114 may be appropriate for the circumstances.

The processing resource 102 may make use of cloud databases and/or operate in conjunction with a cloud computing platform. The processing resource 102 may be coupled to and/or communicate with one or more databases (such as database 116). Also, in some forms, as shown in FIG. 1, the one or more databases constitute local storage accessible to the system 100, while in other forms, they may constitute remote storage accessible via the network(s) 114. While one processing resource 102 is shown, in some forms, the functionalities of the processing resource 102 may be implemented on a plurality of processor devices communicating on a network 114.

In addition, the system 100 may include several trained models, such as trained machine learning models. More specifically, in one form, it may include a first trained model 118, a second trained model 120, and a third trained model 122. The operation and interaction of these trained models 118, 120, and 122 is described further below. In the example shown in FIG. 1, the trained models 118, 120, and 122 are part of the system 100. For example, they may be stored in machine readable medium/s and executed by processing resources of servers of the system 100. In other forms, one or more of the trained models 118, 120, and 122 may be stored in machine readable mediums and executed by processing resources of servers separate from the system 100 and may be accessible by the network 114, such as where the trained models 118, 120, and 122 may be maintained on a cloud computing platform or database. In some forms, the processing resource 102 and the machine readable medium 104 may be part of a cloud computing system and at least one of the first trained model 118, the second trained model 120, and the third trained model 122 may be executed by the cloud computing system.

The system 100 may also communicate with one or more LLMs 124 via network 114. In some forms, it is contemplated that a single LLM may be used to perform the operations described in this disclosure. In other forms, it is contemplated that multiple LLMs may be used that may be implemented one after another in a series operation or that may be implemented at the same time in a parallel operation. In some embodiments, the one or more LLMs 124 may be trained by third parties and residing and executed in a third party cloud server environment. In some embodiments, example LLMs include: GPT-4 and ChatGPT from OpenAI; BERT, T5, Bard from Google; Claude 3.5; Llama from Meta; and Bing Chat from Microsoft. In some embodiments, the one or more LLMs 124 may be downloaded from third parties and trained using data specific to the system 100, and executed on server/s controlled by the system 100 developer.

In some embodiments, one or more of the first trained model 118, the second trained model 120, and the third trained model 122 may be implemented as LLM agents. LLM agents are model interfaces that may be systems built on top of a machine learning model (e.g., an LLM) that may interact with external tools and application programming interfaces (APIs). A machine learning agent may further maintain a state and/or context across multiple steps by calling a machine learning model multiple times and recalling the input(s) and/or output(s) of each call. In some aspects, a machine learning agent may autonomously work toward specific goals (e.g., by planning a series of steps and delegating the steps to additional machine learning models). In other words, a machine learning agent utilizes machine learning models along with additional tools (e.g., open-source resources, search engines, additional models, etc.) in order to complete tasks.

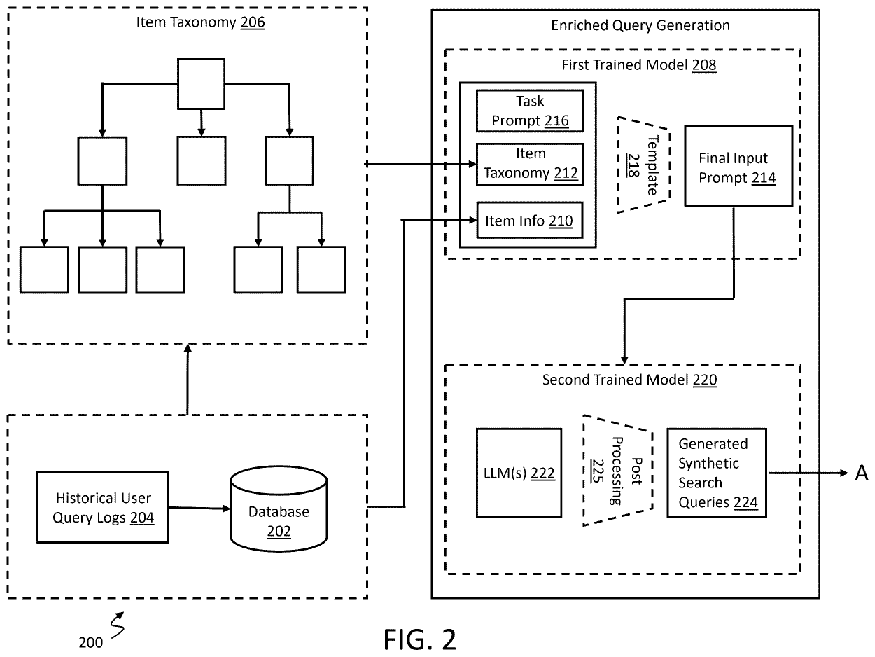

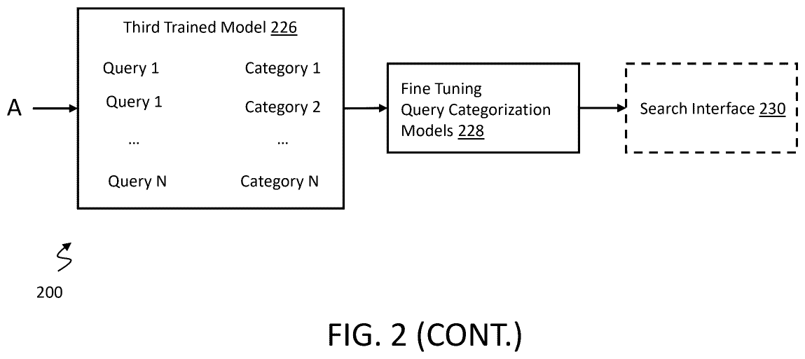

FIG. 2 depicts a block diagram showing a general example of a system 200 that uses trained models and LLM(s) to generate synthetic search queries associated with item categories. FIG. 2 depicts an example of how the processing resource 102 executing instructions 105 of FIG. 1 uses models 118, 120, and 122 to perform the functionality described above as further detailed below with respect to FIG. 2. In some forms, it is generally contemplated that trained models 208, 220, and 226 may be analogous to trained models 118, 120, and 122; LLM(s) 222 may be analogous to LLM(s) 124; and database 202 may be analogous to database 116.

In one form, there is a database 202 that may include historical user query logs 204 and other item information. The historical user query logs 204 may include past user search queries that have been received through the search interface of an ecommerce platform. These are actual past user search queries and may also include the items and/or item categories that were returned to the user in response. In other words, the database 202 may include historical user query logs 204 containing past user search queries directed to items of interest to users in one or more item categories. As addressed below, it is generally contemplated that these actual past user search queries may be submitted as one of the inputs to a trained model.

In one form, there is an item taxonomy 206 showing an organizational relationship of items or item categories to one another. In other words, the item taxonomy 206 is generally an item classification showing a relationship of an item and/or related items in one or more item categories to other items. In some forms, this item taxonomy or classification may segment the item and related items into hierarchical categories. As addressed below, it is generally contemplated that this item taxonomy, e.g., relationship of items and item categories, may be submitted as one of the inputs to a trained model. The closeness of the relationship of various items and/or item categories may be an input when generating the synthetic queries. However, it has also been found that this item taxonomy may result in underrepresented items or item categories, such as, for example, new items or cold start item categories (new item categories).

Items in a catalog can have many features or attributes that in part define them. A catalog generally refers to any listing of one or more items and may include any of various kinds of information about the items. For example, it may contain an item title, item description, and/or a listing of features and attributes of the item. The processing resource 102 may use a first trained model 208 to assess items in the catalog to determine the most relevant features of that item from a searching standpoint. This determination may be referred to as determining the material metadata fields for the items. The processing resource 102 via the first trained model 208 may use the historical search queries for the item and other item information 210, which may also include input provided by sellers of the items. In some forms, the item catalog may include input from individuals selling the item and/or related items regarding the features and attributes of the item and/or related items. It may use this item information 210 together with the item taxonomy 212 (organization of item features) to generate metadata fields. As one example, color, size, weight, screen size, battery life may be some relevant metadata fields for a smartphone.

In other words, the processing resource 102 may use the first trained model 208 to generate the metadata fields for an item of an item catalog including features and attributes of the item. The processing resource 102 via the first trained model 208 uses one or more of the past user search queries from the historical user query logs 204, an item classification (or item taxonomy 212) showing a relationship of the item and/or related items in the one or more item categories to other items, and the features and attributes of the item and/or related items. The processing resource 102 via the first trained model 208 may use a task prompt 216 and a template 218 in conjunction with submitting the inputs to generate final input prompt(s) 214. The task prompt 216 may provide instructions or input to generate the final input prompt 214 for input to LLM(s) 222. The final input prompt 214 may be in the form of and/or makes use of the most relevant metadata fields for an item or item category.

Once the relevant metadata fields are determined, the processing resource 102 may use a second trained model 220 in conjunction with one or more LLMs 222. The processing resource 102 via the second trained model 220 may use the final input prompt(s) 214 to query the LLMs 222 to generate example search queries, e.g., synthetic search queries 224, that may be asked by a user directed to the metadata fields. The prompts 214 to the LLM(s) 222 provide the LLM(s) 222 information about the item, including features and characteristics, which may be the input text provided to guide the model towards generating the synthetic search queries 224.

The processing resource 102 via the second trained model 220 instructs the LLM(s) 222 to generate the synthetic search queries 224. The processing resource 102 via second trained model 220 submits the prompt(s) 214 to the LLM(s) 222 and receives back the generated synthetic search queries 224. Post-processing 225, such as by feedback, may be used to adjust the output of the LLM(s) 222, as necessary or desired. In the example of a phone, synthetic search queries 224 returned by the LLM(s) 222 may include: iPhone 15, best smartphone, blue iPhone, etc. In this way, many synthetic search queries 224 can be generated for new items or items in a different category, and so on.

In other words, the processing resource 102 using the second trained model 220 may generate prompt(s) including the features and attributes of the item and/or the metadata fields. These prompt(s) may be the final input prompt(s) 214, which may be modified in some form to make them more suitable for the LLM(s) 222. The processing resource 102 via the second trained model 220 queries the LLM(s) 222 to generate synthetic search queries 224 that may be asked by a user directed to the metadata fields. The processing resource 102 then receives the synthetic search queries 224 from the LLM(s) 222.

In some forms, it is contemplated that the first and second trained models 208 and 220 may be components of a single, comprehensive trained model. This single trained model may initially generate the metadata fields and the final input prompt(s) 214 for the LLM(s) 222, and it may then use the final input prompt(s) 214 to run the LLM(s) 222 to generate the synthetic search queries 224. In this form, the single trained model may be viewed as performing an intermediate step of generating the final input prompt(s) 214 before a final step of generating the synthetic search queries 224.

The system 200 may also utilize a third trained model 226, e.g., a trained categorization model. The processing resource 102 using the third trained model 226 maps the received synthetic search queries 224 with item categories. The third trained model 226 generates various combinations of synthetic search queries 224 and item categories. The third trained model 226 maps each of the received synthetic search queries 224 to at least one item category.

This third trained model 226 may be used to generate a ground truth in machine learning that seeks to represent a target for training or validating a model. This ground truth may represent the goal or benchmark that is sought to be achieved. For example, at block 228, it is contemplated that the results of the third trained model 226 may be used to fine tune another trained model, e.g., to fine tune one or more query categorization model(s). These query categorization model(s) may be associated with the search interface 230 and with user search queries received at the search interface 230.

Also, in some forms, it is contemplated that the trained models 208, 220, and 226 themselves may be fine tuned continuously or periodically. For example, it is contemplated that the system 200 may use reinforcement learning models to adjust and/or improve one or more of the trained models 208, 220, and 226. Further, the fine tuning may include query overrides and/or manual evaluation. For example, in some forms, the processing resource 102 may instruct a reinforcement learning model and receive feedback to modify the first trained model 208, the second trained model 220, and/or the third trained model 226.

The association of synthetic search queries, relevant metadata, and item categories may increase the data available regarding an item category, which may consequently improve relevancy of search results generated from a user search query. It may help return new items and item categories and items and item categories that may have been underrepresented in response to past user search queries. For example, when a user later searches for a “blue iPhone”, the system 200 may use the mapping and return relevant items and item categories in the search results. As stated, these synthetic search queries (and the corresponding mapped item categories) may be used to modify query categorization model(s) that are associated with the search interface.

In one form, the system 200 may use trained models and LLM(s) to generate synthetic search queries based on relevant item metadata and constantly evolving item taxonomy. It may use trained models and LLM(s) to reflect ecommerce behavior to generate synthetic search queries by providing examples. It may also use generated synthetic search queries and LLM(s) to generate ground truth for query categorization. It may use the synthetic search queries to fine tune query categorization models to improve searching. Further, the synthetic search queries may be used to update item classification/taxonomy. In one form, the processing resource may update and modify the item classification based on the mapping of received synthetic search queries to item categories. It may provide greater precision in returning relevant items with underrepresented item attributes when a user searches through an interface.

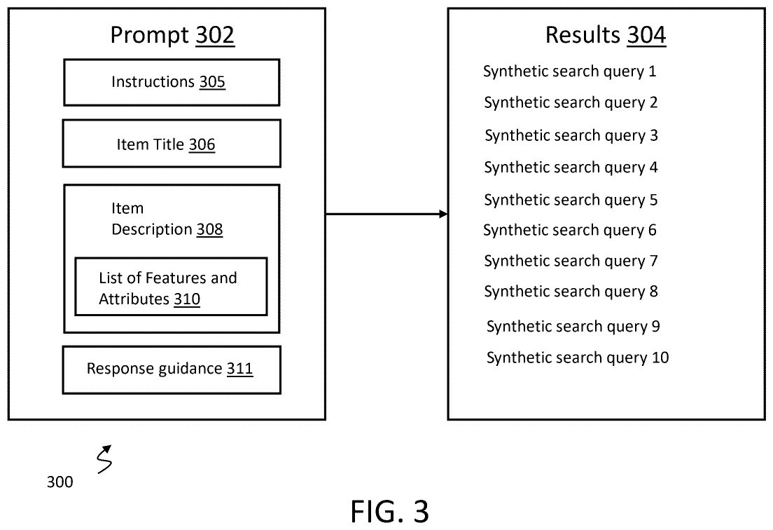

FIG. 3 depicts an example system 300 that includes a prompt 302 involving an item and the generated results 304 in the form of generated synthetic search queries. In this form, it is generally contemplated that this prompt 302 corresponds to the final input prompt 214 in FIG. 2. The prompt 302 may include natural language text, structured text, item titles, item descriptions, any other text format, and/or combinations thereof. For example, the prompt 302 may include the following initial instructions 305: “You are an eCommerce relevance expert. You work for a search-based platform of an eCommerce company. An eCommerce catalog item setup includes defining categories for a homogeneous set of items so that finding items that are similar becomes easier. Users come and search for relevant items using search queries on the platform. They expect to find items from relevant categories. Your task is to look at items in the catalog and recommend relevant search queries that users may type to search for these items. Generate at least 10 relevant search queries that users may type to look for these items. Make sure the queries need not match just on exact words but can also be semantically (meaningfully) relevant. You can use the following metadata of the items to generate these queries.”

Next, following these instructions 305, the prompt 302 may include a list of various items for which synthetic search queries are to be generated. In some forms, for each item, the prompt 302 may include an item title 306 and an item description 308. As an example, the item title 306 may be “Memory Foam Futon, Memory Foam Futon with Foldable Armrest.” Further, in this example, the item description 308 might include the following: “When last-minute guests show up, the Mainstays memory foam futon comfortably pulls double duty to save you space and money. Featuring a clean-lined wooden frame with durable metal legs, this impressive futon is extra seating and a foldable bed in one. Designed to take any room from day to night, a split seat and back design with fold-up arms quickly and easily convert the futon from a sofa to lie flat in a flash. The pillow top cushioning is constructed from extra-supportive memory foam to deliver plenty of lounges and snooze-worthy comfort. Whether you are looking for furniture for your dorm or are in need of a small-space solution for your apartment, the Mainstays memory foam futon is a stylish and practical convertible sofa that works for your comfort.” Optionally, the item description 308 may end with a list of features and attributes 310, such as, for example, “easily adjusts to upright and flat positions,” “black fabric with black trim,” etc.

In some embodiments, the prompts 302 may include guidance 311 as for the intended output, e.g., specifying one or more of the form or format of the response, words/phrases to avoid, and requesting that the LLM not hallucinate (i.e., base its answers on the information given and not make up answers or information). For example, in some embodiments, an example prompt 302 may include the following: “Note: Do not hallucinate, only use the given product information to generate queries. Only generate search queries and don't add other explanation of text from your end like hello, sure, absolutely. Your output should be in the following format, replace <search_query>with your search queries: #<search_query_1>, #<search_query_2>”.

Prompts 302 may be generated in various ways. The above example may be considered a form of abstractive prompt, which allows for generating synthetic queries that are not included verbatim in the item title 306, item description 308, or features and attributes 310. In other forms, it may be desirable to use an extractive prompt, which extracts language from the item title 306, item description 308, or features and attributes 310. In some forms, it is contemplated that templates (such as template 218) may be completed with specific information, such as item metadata, to generate the prompts 214/302.

After the prompt 302 is inputted, the system 300 generates the results 304. More specifically, after querying the LLM(s), the system 300 generates a listing of synthetic search queries. These synthetic search queries are relevant search queries that users might submit to search for this item. In this example, the synthetic search queries included: memory foam futon, convertible futon sofa, futon with foldable armrest, space-saving futon sofa bed, futon for dorm rooms, small-space solution futon, black fabric futon, easy to assemble futon, sofa to sleeper in seconds, and futon with sturdy wood frame and metal legs. A third trained model may then be used to map these synthetic search queries to item categories, which, in turn, may be used to fine tune query categorization models(s) associated with the search interface. It should be understood that this memory foam futon example is provided for illustrative purposes and that many other types of items and item categories may be the subject of this approach.

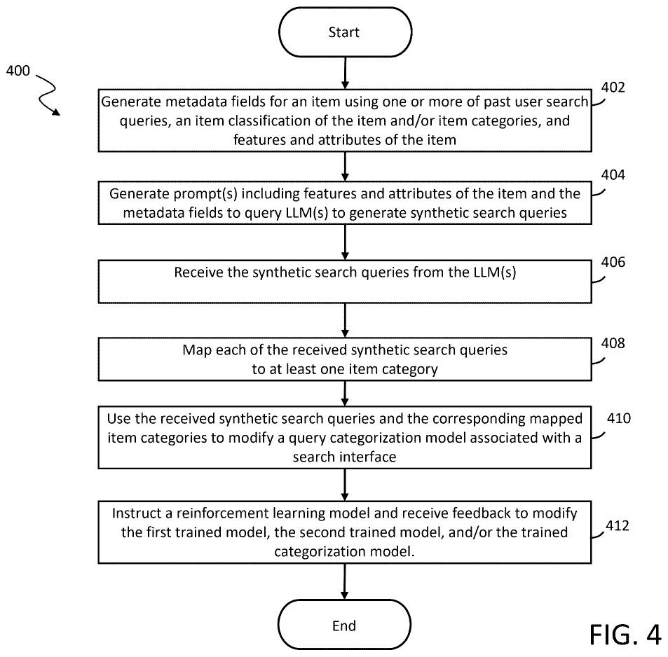

FIG. 4 depicts a flow diagram showing an exemplary method. In some forms, one or more blocks of the method may be performed at about the same time or in a different order than illustrated in the figures. In some forms, the method may not include all of the blocks/steps shown, may include additional blocks/steps, and/or some blocks/steps may be combined. In some forms, some of the blocks/steps may be repeated. It is generally contemplated that the method may be implemented in conjunction with executable instructions stored on a machine readable medium and a processing resource. Additionally, other aspects of the methods for operation may incorporate some of the components shown in FIGS. 1-3, such as the processing resource 102.

FIG. 4 depicts a flow diagram of a process 400 that may be used to generate synthetic search queries. At block 402, metadata fields are generated for an item using one or more of past user search queries, an item classification of the item and/or item categories, and features and attributes of the item. In one form, it is contemplated that a processing resource using a first trained model may generate these metadata fields.

At block 404, prompt(s) may be generated including features and attributes of the item and the metadata fields to query LLM(s) to generate synthetic search queries. In one form, it is contemplated that a processing resource using a second trained model to query the LLM(s) may be used in generating these synthetic search queries. In some forms, the first and second trained models may be part of a single, comprehensive trained model. The LLM(s) use their training on large amounts of data relating to the human language to generate the synthetic search queries. In one aspect, these synthetic search queries are predictions, in view of the metadata fields, of user search queries that may be inputted. At block 406, the synthetic search queries are received from the LLM(s).

At block 408, each of the received synthetic search queries may be mapped to at least one item category. In one form, it is contemplated that a processing resource using a third trained model, e.g., a trained categorization model, may be used to generate these associated pairs of synthetic search query and item category. In one form, it is contemplated that this output may represent a ground truth in machine learning, which may represent a goal or benchmark of what is to be achieved with searching.

At block 410, the received synthetic search queries and the corresponding mapped item categories may be used to modify a query categorization model associated with a search interface. In one form, it is contemplated that the search interface is part of an ecommerce platform receiving user queries directed to items of interest to the user. In one form, it is contemplated that the synthetic search queries and corresponding mapped item categories may be more comprehensive and may include new or underrepresented items and item categories.

At block 412, a reinforcement learning model is instructed and feedback is received to modify the first trained model, the second trained model, and/or the third trained model, e.g., a trained categorization model. It is contemplated that the trained model(s) may need to be adjusted and fine tuned. Feedback, such as, for example, query overrides and manual evaluation, may be used to improve the trained model(s).

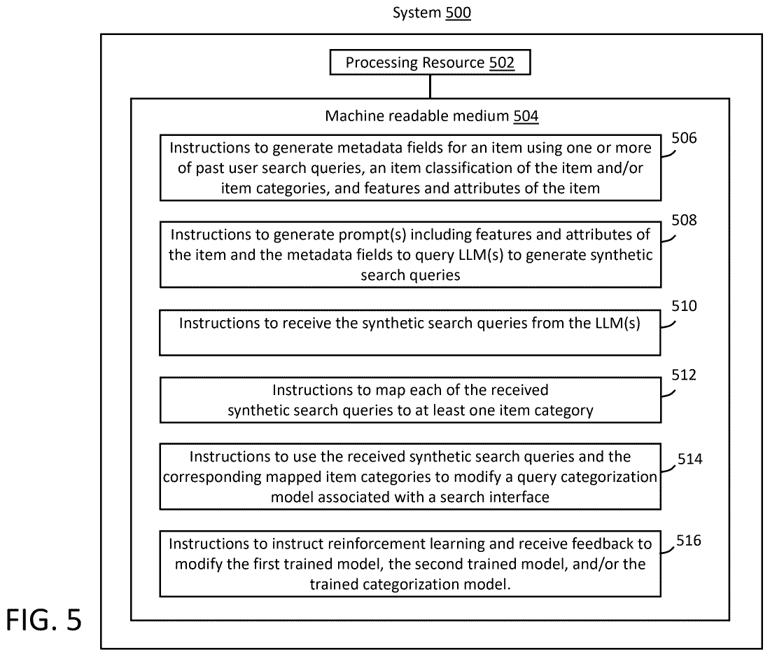

FIG. 5 depicts an example system 500 that includes non-transitory, machine readable media 504 that are encoded with example instructions executable by a processing resource 502. In some forms, the system 500 may be useful for implementing aspects of the systems 100 and 200 of FIGS. 1-2 or for performing aspects of process 400 of FIG. 4. For example, the instructions encoded on machine readable media 504 may be included in instructions 105 of FIG. 1. The processing resource 502 may include a microcontroller, a microprocessor, central processing unit core(s), an ASIC, an FPGA, and/or other hardware device suitable for retrieval and/or execution of instructions from the machine readable media 504 to perform functions related to various examples. Additionally, or alternatively, the processing resource 502 may include or be coupled to electronic circuitry or dedicated logic for performing some or all of the functionality of the instructions described herein.

The machine readable media 504 may be of any medium suitable for storing executable instructions, such as RAM, ROM, EEPROM, flash memory, a hard disk drive, an optical disc, or the like. In some examples, the machine readable media 504 may be a tangible, non-transitory medium. The machine readable media 504 may be disposed within the systems 100 and 200 respectively, in which case the executable instructions may be deemed installed or embedded on the system. Alternatively, the machine readable media 504 may be a portable (e.g., external) storage medium.

As described further herein below, the machine readable media 504 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIG. 5.

In FIG. 5, instructions may be used to generate synthetic search queries. Instructions 506, when executed, cause the processing resource 502 to generate metadata fields for an item using one or more of past user search queries, an item classification of the item and/or item categories, and features and attributes of the item. These metadata fields help categorize items under relevant item categories. Instructions 508, when executed, cause the processing resource 502 to generate prompt(s) including features and attributes of the item and the metadata fields to query LLM(s) to generate the synthetic search queries. Instructions 510, when executed, cause the processing resource 502 to receive the synthetic search queries from the LLM(s). In one form, it is contemplated that one or more trained models may be used to determine and input these prompts to LLM(s) to generate these synthetic search queries as the results or output.

Instructions 512, when executed, cause the processing resource 502 to map each of the received synthetic search queries to at least one item category. In one form, it is generally contemplated that a trained categorization model may be used to associate the synthetic search queries to item categories. In one form, this mapping represents the ground truth of the machine learning trained model(s).

Instructions 514, when executed, cause the processing resource 502 to use the received synthetic search queries and the corresponding mapped item categories to modify a query categorization model associated with a search interface. In other words, the ground truth may be used to modify or improve the query categorization model and, in turn, the overall searching. Instructions 516, when executed, cause the processing resource 502 to instruct reinforcement learning models and receive feedback to modify the first trained model, the second trained model, and/or the trained categorization model. Feedback may be used to fine tune the trained model(s).

Generally speaking, pursuant to various embodiments, systems, apparatuses, and methods are provided herein useful to generating synthetic search queries. In some embodiments, there is provided a system including: a database including a plurality of historical user query logs containing a plurality of past user search queries directed to items of interest to users in one or more item categories; a processing resource; and a machine readable medium storing instructions. The instructions, when executed by the processing resource, cause the processing resource to: generate, using a first trained model, a plurality of metadata fields for an item of an item catalog including features and attributes of the item, wherein the first trained model uses one or more of the plurality of past user search queries from the plurality of historical user query logs, an item classification showing a relationship of the item and/or related items in the one or more item categories to other items, and the features and attributes of the item and/or related items; generate, using a second trained model, at least one prompt including the features and attributes of the item and the plurality of metadata fields to query one or more large language models (LLMs) to generate synthetic search queries that may be asked by a user directed to each metadata field of the plurality of metadata fields; receive the synthetic search queries from the one or more LLMs; and map, using a trained categorization model, each of the received synthetic search queries to at least one item category.

In some implementations, the item catalog includes input from individuals selling the item and/or related items regarding the features and attributes of the item and/or related items. In some implementations, the item catalog includes a title and description for each item in the item catalog. In some implementations, the item classification segments the item and related items into hierarchical categories. In some implementations, system further includes instructions that, when executed, cause the processing resource to: instruct a reinforcement learning model and receive feedback to modify the first trained model, the second trained model, and/or the trained categorization model. In some implementations, in the system, the plurality of past user search queries were received through an interface of an ecommerce platform. In some implementations, the system further includes instructions that, when executed, cause the processing resource to: modify the item classification based on the mapping of each of the received synthetic search queries to the at least one item category. In some implementations, in the system, the received synthetic search queries and the corresponding mapped item categories are used to modify a query categorization model associated with a search interface of an ecommerce platform, the query categorization model mapping user search queries to items and/or item categories. In some implementations, the one or more LLMs include a plurality of LLMs that are implemented one after another in a series operation or that are implemented at the same time in a parallel operation. In some implementations, the processing resource and the machine readable medium are part of a cloud computing system and at least one of the first trained model, the second trained model, and the trained categorization model are executed by the cloud computing system.

In another form, there is a method including: generating, using a first trained model, a plurality of metadata fields for an item of an item catalog including features and attributes of the item, wherein the first trained model uses one or more of a plurality of past user search queries from a plurality of historical user query logs, an item classification showing a relationship of the item and/or related items in one or more item categories to other items, and the features and attributes of the item and/or related items; generating, using a second trained model, at least one prompt including the features and attributes of the item and the plurality of metadata fields to query one or more large language models (LLMs) to generate synthetic search queries that may be asked by a user directed to each metadata field of the plurality of metadata fields; receiving the synthetic search queries from the one or more LLMs; and mapping, using a trained categorization model, each of the received synthetic search queries to at least one item category.

In some implementations, the method further includes instructing a reinforcement learning model and receiving feedback to modify the first trained model, the second trained model, and/or the trained categorization model. In some implementations, the method further includes modifying the item classification based on the mapping of each of the received synthetic search queries to the at least one item category. In some implementations, the method further includes using the received synthetic search queries and corresponding mapped item categories are used to modify a query categorization model associated with a search interface of an ecommerce platform, the query categorization model mapping user search queries to items and/or item categories. In some implementations, the method further includes: executing at least one of the first trained model, the second trained model, and the trained categorization model by a cloud computing system.

In another form, there is provided a non-transitory machine readable medium storing instructions that, when executed, cause a processing resource to: generate, using a first trained model, a plurality of metadata fields for an item of an item catalog including features and attributes of the item, wherein the first trained model uses one or more of a plurality of past user search queries from a plurality of historical user query logs, an item classification showing a relationship of the item and/or related items in one or more item categories to other items, and the features and attributes of the item and/or related items; generate, using a second trained model, at least one prompt including the features and attributes of the item and the plurality of metadata fields to query one or more large language models (LLMs) to generate synthetic search queries that may be asked by a user directed to each metadata field of the plurality of metadata fields; receive the synthetic search queries from the one or more LLMs; and map, using a trained categorization model, each of the received synthetic search queries to at least one item category.

In some implementations, the instructions, when executed, cause the processing resource to instruct a reinforcement learning model and receive feedback to modify the first trained model, the second trained model, and/or the trained categorization model. In some implementations, the instructions, when executed, cause the processing resource to modify the item classification based on the mapping of each of the received synthetic search queries to the at least one item category. In some implementations, the one or more LLMs include a plurality of LLMs that are implemented one after another in a series operation or that are implemented at the same time in a parallel operation. In some implementations, the processing resource and the machine readable medium are part of a cloud computing system; and the instructions, when executed, cause the processing resource to execute at least one of the first trained model, the second trained model, and the trained categorization model by the cloud computing system.

In another form, there is provided a system including: a first trained model to be stored in a machine readable medium and to be executed by a processing resource, the first trained machine learning model to generate a plurality of metadata fields for an item of an item catalog including features and attributes of the item, wherein the first trained model uses one or more of a plurality of past user search queries from a plurality of historical user query logs, an item classification showing a relationship of the item and/or related items in one or more item categories to other items, and the features and attributes of the item and/or related items; a second trained model to be stored in the machine readable medium and to be executed by the processing resource, the second trained machine learning model to generate at least one prompt including the features and attributes of the item and the plurality of metadata fields to query one or more large language models (LLMs) to generate synthetic search queries that may be asked by a user directed to each metadata field of the plurality of metadata fields; and a trained categorization model to be stored in the machine readable medium and to be executed by the processing resource, the trained categorization machine learning model to map each of the generated synthetic search queries to at least one item category. In some implementations, the processing resource includes a plurality of processing resources and the machine readable medium comprises a plurality of machine readable mediums.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a database including a plurality of historical user query logs containing a plurality of past user search queries directed to items of interest to users in one or more item categories;
a processing resource; and
a machine readable medium storing instructions that, when executed by the processing resource, cause the processing resource to:
instruct a first trained model to generate a plurality of metadata fields for an item of an item catalog including features and attributes of the item, wherein the first trained model uses one or more of the-plurality of past user search queries from the plurality of historical user query logs, an item classification showing a relationship of the item and/or related items in the one or more item categories to other items, and the features and attributes of the item and/or related items;
instruct a second trained model to generate at least one input prompt including the features and attributes of the item and the plurality of metadata fields to query one or more large language models (LLMs) to generate synthetic search queries that may be asked by a user directed to each metadata field of the plurality of metadata fields;
receive the synthetic search queries from the one or more LLMs;
map, using a trained categorization model, each of the received synthetic search queries to at least one item category;
use the received synthetic search queries and the corresponding mapped item categories as ground truth to modify the trained categorization model such that the trained categorization model is fine tuned using the synthetic search queries for item categories that are new or underrepresented in the historical user query logs; and
use the fine tuned trained categorization model in connection with a search interface to increase identification of relevant item categories for subsequent user search queries associated with the new or underrepresented item categories.

2. The system of claim 1, wherein the item catalog comprises input from individuals selling the item and/or related items regarding the features and attributes of the item and/or related items.

3. (canceled)

4. The system of claim 1, wherein the item classification segments the item and related items into hierarchical categories.

5. The system of claim 1, further comprising instructions that, when executed, cause the processing resource to: instruct a reinforcement learning model and receive feedback to modify the first trained model, the second trained model, and/or the trained categorization model.

6. (canceled)

7. The system of claim 1, further comprising instructions that, when executed, cause the processing resource to: modify the item classification based on the mapping of each of the received synthetic search queries to the at least one item category.

8. The system of claim 1, wherein the received synthetic search queries and corresponding mapped item categories are used to modify the trained categorization model associated with the search interface of an ecommerce platform, the trained categorization model mapping user search queries to items and/or item categories.

9. The system of claim 1, wherein the one or more LLMs comprise a plurality of LLMs that are implemented one after another in a series operation or that are implemented at the same time in a parallel operation.

10. The system of claim 1, wherein the processing resource and the machine readable medium are part of a cloud computing system and at least one of the first trained model, the second trained model, and the trained categorization model are executed by the cloud computing system.

11. A method comprising:
instructing a first trained model to generate a plurality of metadata fields for an item of an item catalog including features and attributes of the item, wherein the first trained model uses one or more of a plurality of past user search queries from a plurality of historical user query logs, an item classification showing a relationship of the item and/or related items in one or more item categories to other items, and the features and attributes of the item and/or related items;
instructing a second trained model to generate at least one prompt including the features and attributes of the item and the plurality of metadata fields to query one or more large language models (LLMs) to generate synthetic search queries that may be asked by a user directed to each metadata field of the plurality of metadata fields;
receiving the synthetic search queries from the one or more LLMs;
mapping, using a trained categorization model, each of the received synthetic search queries to at least one item category;
using the received synthetic search queries and the corresponding mapped item categories as ground truth to modify the trained categorization model such that the trained categorization model is fine tuned using the synthetic search queries for item categories that are new or underrepresented in the historical user query logs; and
using the fine tuned trained categorization model in connection with a search interface to increase identification of relevant item categories for subsequent user search queries associated with the new or underrepresented item categories.

12. The method of claim 11, further comprising instructing a reinforcement learning model and receiving feedback to modify the first trained model, the second trained model, and/or the trained categorization model.

13. The method of claim 11, further comprising modifying the item classification based on the mapping of each of the received synthetic search queries to the at least one item category.

14. The method of claim 11, further comprising using the received synthetic search queries and corresponding mapped item categories are used to modify the trained categorization model associated with the search interface of an ecommerce platform, the trained categorization model mapping user search queries to items and/or item categories.

15. (canceled)

16. A non-transitory machine readable medium storing instructions that, when executed, cause a processing resource to:
instruct a first trained model to generate a plurality of metadata fields for an item of an item catalog including features and attributes of the item, wherein the first trained model uses one or more of a plurality of past user search queries from a plurality of historical user query logs, an item classification showing a relationship of the item and/or related items in one or more item categories to other items, and the features and attributes of the item and/or related items;
instruct a second trained model to generate at least one prompt including the features and attributes of the item and the plurality of metadata fields to query one or more large language models (LLMs) to generate synthetic search queries that may be asked by a user directed to each metadata field of the plurality of metadata fields;
receive the synthetic search queries from the one or more LLMs;
map, using a trained categorization model, each of the received synthetic search queries to at least one item category;
use the received synthetic search queries and the corresponding mapped item categories as ground truth to modify the trained categorization model such that the trained categorization model is fine tuned using the synthetic search queries for item categories that are new or underrepresented in the historical user query logs; and
use the fine tuned trained categorization model in connection with a search interface to increase identification of relevant item categories for subsequent user search queries associated with the new or underrepresented item categories.

17. The non-transitory machine readable medium of claim 16,
wherein the instructions, when executed, cause the processing resource to instruct a reinforcement learning model and receive feedback to modify the first trained model, the second trained model, and/or the trained categorization model.

18. The non-transitory machine readable medium of claim 16,
wherein the instructions, when executed, cause the processing resource to modify the item classification based on the mapping of each of the received synthetic search queries to the at least one item category.

19. The non-transitory machine readable medium of claim 16,
wherein the one or more LLMs comprises a plurality of LLMs that are implemented one after another in a series operation or that are implemented at the same time in a parallel operation.

20. The non-transitory machine readable medium of claim 16, wherein:
the processing resource and the machine readable medium are part of a cloud computing system; and:
the instructions, when executed, cause the processing resource to execute at least one of the first trained model, the second trained model, and the trained categorization model by the cloud computing system.

21. The system of claim 1, wherein using the received synthetic search queries and the corresponding mapped item categories as ground truth to modify the trained categorization model comprises adjusting category association weights or decision boundaries for new or underrepresented item categories.

22. The system of claim 1, further comprising, instructions that, when executed by the processing resource, cause the processing resource to validate the trained categorization model based on one or more evaluation signals derived from subsequent search activity or feedback data.

23. The system of claim 1, wherein using the fine tuned trained categorization model in connection with a search interface comprises modifying at least one of: selection of item categories eligible for retrieval, and ranking of items presented by the search interface.
